(19) United States
(12) Patent Application Publication
(10) Pub. No.: US 2011/0308483 A1
(43) Pub. Date: Dec. 22, 2011

(54) Nitrous-oxide system for internal combustion engine

(76) Inventor: Kenneth Don Lafferty, Walker, LA (US)

(21) Appl. No.: 12/803,074

(22) Filed: Jun. 18, 2010

(51) Int. Cl. F01P 9/00; F02B 23/00

(52) U.S. Cl. 123/41.01; 123/585

(57) ABSTRACT

A system and method for retrofitting a fuel delivery system of vehicle having internal combustion engine is disclosed. The system allows delivery of nitrous oxide in a dense liquid form from a nitrous oxide bottle directly to each of the engine cylinders. A cooling unit is mounted between the nitrous oxide bottle and the engine so as to retain the nitrous oxide in a cold liquid condition. A nozzle assembly that introduces the nitrous oxide and engine fuel into a cylinder has a reduced size orifice, in the order of 0.01-0.05″.

### BACKGROUND OF THE INVENTION

The present invention relates a system designed to increase performance of a gasoline-powered internal combustion engine using a cryogen, such as nitrous oxide.

Race car drivers continuously strive to increase engine performance. One of the ways that an internal combustions engine can produce higher power output is to improve the oxygen content in the air and gasoline mixture. Nitrous Oxide is a chemical that is rich in Nitrogen and Oxygen. Injecting nitrous oxide into an engine intake increases the oxygen density of the intake air. Nitrogen is a cryogenic liquid with a very high vapor pressure. It must be kept at a minimum of 745 psi to remain a liquid at room temperature. Since the vapor pressure is so high as a liquid at room temperature, when nitrous oxide is released into the atmosphere, there is a very rapid expansion as it metamorphoses from a liquid to a gas. There is a large amount of evaporative cooling that takes place as the liquid evaporates, drastically reducing the temperature of the surrounding air.

Nitrous-oxide systems are designed to inject compressed nitrous-oxide into the combustion chamber of an engine during the fuel intake stroke of the combustion chamber piston to provide more oxygen for combustion. The increased oxygen level allows more fuel to be injected during the intake stroke of the piston. The increase in fuel and oxygen during the combustion cycle results in greater energy being transferred to the piston which increases the stroke cycle of the piston. The increased stroke cycle of the pistons is then transferred to the cam shaft which ultimately results in an increase in horse power of the engine.

The higher air density and oxygen percentages allow for more fuel to burn, creating large amounts of power. This cooler air lowers the chances of premature detonation which can be damaging to internal engine components. Just the cooler air alone can increase an engine horsepower by about 5 percent. In essence, nitrous oxide is one of the simplest ways to provide a significant horsepower boost to any gasoline engine.

Nitrogen serves several functions. The nitrogen atoms have a cooling effect on the combustion temperature by absorbing the heat and carrying it away. Nitrogen can effectively cool the intake temperature by 16 to 24 degrees Celsius (i.e. approximately 60 to 75 degrees Fahrenheit). Additionally, with every 10 degree Fahrenheit drop in temperature the total horsepower output will increase by approximately one percent. This means that over and above the power output derived from the oxygen-petrol combustion process, the horsepower output of an engine when using a nitrous-oxide system can be increased by about six to seven percent.

Typically, nitrous oxide is stored in a container under pressure as a liquid in equilibrium with its vapor, thereby allowing a relatively high mass storage density. Since the vapor pressure of nitrous oxide increases with increasing temperature, the bottle pressure increases with temperature. For instance, at 0 degrees Celsius, the bottle pressure is 31E06 dynes/cm ̂2 (450 pounds per square inch (PSI)); when at 25 degrees Celsius, the bottle pressure is 55E06 dynes/cm̂2 (815 PSI).

Liquid nitrous oxide leaves the bottle through its valve, then typically goes through a solenoid operated activation valve, through appropriate delivery lines, and finally to a nozzle which delivers the nitrous oxide to the engine. This nozzle contains a jet or orifice which controls mass flow rate. At the entrance to the nitrous jet, the pressure is essentially the same (only slightly less) than the bottle pressure, but as it passes through the jet, its pressure decreases to typically essentially atmospheric pressure, it vaporizes, and its temperature decreases significantly. At atmospheric pressure, liquid nitrous oxide has a boiling point of −88 degrees Celsius, and this is essentially the temperature at which the nitrous oxide vapor exits the nitrous jet. It would be beneficial to provide a system that will maintain the released nitrous oxide in a cold state while it travels from the container to the injection point so as to maintain the nitrous oxide in a liquid state as long as possible.

Another important consideration for the nitrous oxide injection systems is the size of the orifice in the delivery nozzle to allow regulation of the flow rate to the engine. In a conventional liquid system, the orifice size of the nitrous jet is about 0.20 mm (0.008 inches) depending on the bottle temperature. This jet is difficult and expensive to manufacture due to its small orifice size. It will be beneficial to provide a nitrous delivery jet with an orifice size sufficient to permit liquid nitrous oxide to exit the system, while maintaining the desired flow rate of about 1 g/sec.

### SUMMARY OF THE INVENTION

It is, therefore, an object of the present invention to provide a nitrous-oxide system for use with internal combustion engines to increase the engine performance.

It is another object of the invention to provide a nitrous oxide engine system that operates on a direct-port principle, delivering nitrous oxide mixed with fuel directly into the engine.

It is a further object of the invention to provide a nitrous oxide engine system designed to retain the nitrous oxide in a liquid form up to the point of mixing with the engine fuel.

These and other objects of the invention are achieved through a provision of nitrous-oxide system for an internal combustion engine having a fuel line for delivery of fuel to the engine. The system comprises a closed container with nitrous oxide under pressure, a high pressure first conduit connected to the container and configured for delivery of nitrous oxide from the container, and a cooling unit mounted downstream from the first conduit.

The cooling unit has a housing sized and configured to retain a discreet length (about 40 feet) of hollow cooling tubing, which can be one or more tubing coils. The coiled tubing is fluidly connected to a free end of the first conduit allowing the nitrous oxide to travel through the cooling unit. A cooling medium, such as ice, is deposited into the housing in a surrounding relationship to the cooling tubing in order to keep the nitrous oxide in a cold dense condition without vaporization.

A second conduit is fluidly connected to an outlet end of the cooling tubing for transporting the nitrous oxide to a manifold, where the nitrous oxide is mixed with engine fuel and delivered to directly to the engine cylinders. A nozzle assembly for each cylinder is operationally connected to the second conduit and operatively coupled to an engine intake, the nozzle assembly comprising a jet nozzle fitting configured to inject a mixture of nitrous oxide and fuel into the engine intake. The nozzle fitting has an orifice of a reduced size, in the order of 0.01 to 0.05″.

The system is solenoid-operated when the driver starts the engine and presses an accelerator pedal.

### BRIEF DESCRIPTION OF THE DRAWINGS

Reference will now be made to the drawings, wherein like parts are designated by like numerals, and wherein

FIG. 1 is a schematic view of the nitrous oxide system of the present invention.

FIG. 2 is a schematic view illustrating injection of nitrous oxide and fuel mixture into the engine.

FIG. 3 is detail view illustrating a nitrous oxide/fuel nozzle adapted for use in the system of the present invention.

### DETAIL DESCRIPTION OF THE INVENTION

Turning now to the drawings in more detail, numeral 10 designates the system of the present invention. The system 10 is a wet direct port nitrous system, which introduces liquid nitrous oxide and fuel directly into each intake port on the engine. In this system, the fuel and cryogen (nitrous oxide) are combined to pass through a nozzle for delivery to each cylinder individually, allowing each cylinder's nitrous/fuel ratio to be adjusted without affecting the other cylinders.

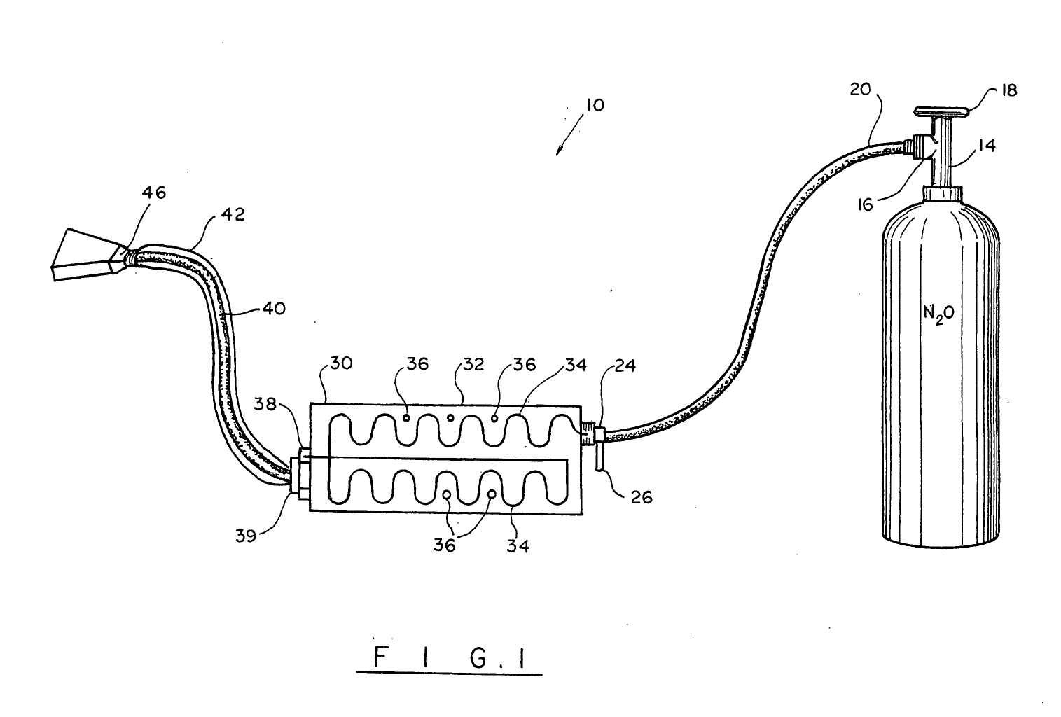

As can be seen in FIG. 1, the system 10 comprises a source of nitrogen oxide or container 12, which stores a discreet amount of liquid nitrogen oxide under pressure. In a preferred embodiment, the container 12 is provided with a safety valve 14 and a normally closed flow rate valve 18, which opens the container 12 and allows the nitrous to exit the container 12. The flow rate valve 18 is opened when filling the container 12 and prior to the system 10 used in the field.

The flow rate valve 18 is connected to a regulator valve 16, which is configured to provide a relatively constant regulated flow rate of nitrous oxide from the container 12 regardless of internal pressure in the bottle 12. The flow rate valve 16 is usually solenoid operated and activated by a car driver who presses on the accelerator pedal.

A first high pressure conduit 20 connects the regulator valve 16 to a cooling unit 30 through a check valve 24. The check valve 24 can be ball valve with a hand-operated lever 26. Typically, the internal pressure within the container 12 is maintained at between 800 and 1000 p.s.i.

The cooling unit 30 comprises a housing 32 having a closed bottom and upwardly extending sidewalls, which in combination form a chamber configured for housing one or more refrigeration coils or hollow cooling tubing 34. The liquid nitrous oxide is forced to travel through the refrigeration coil(s) 34 under pressure. The refrigeration coils can be made of a non-corrosive material, such as for instance 0.5″ stainless steel tubing. A cooling medium, which can be water ice cubes 36, is deposited into the housing 30 in contact with the refrigeration coil(s) 34 to maintain the liquid nitrous in a cool, dense liquid condition. The cooling medium 36 prevents vaporization of the nitrous oxide, while maintaining the temperature of the nitrous oxide at or below 0° C.

If a water ice is used as a cooling medium, the temperature of nitrous oxide travelling through the coil tubing 34 is maintained at about 0° C. In the alternative, dry ice may be used, in which case the temperature of the nitrous oxide may be even lower. In the preferred embodiment, the amount of cooling medium 36 is sufficient to surround the coil(s) 34 within the housing 32. It is envisioned that another alternative cooling system can use a compressor to generate lower temperature transfer of nitrous oxide from the bottle 12 to the engine of a car. In one aspect of the invention, the system 10 incorporates about 40 feet of coil tubing, one-half inch in diameter. It is believed that this amount of refrigerated path is sufficient for burn in a typical quarter-mile run.

The cold nitrous oxide exits the housing 32 through a second check valve 38, which can be a ball valve with a hand lever 39. The nitrous oxide then enters a second conduit 40, which allows the cooled nitrous oxide to exit the housing and travel to a manifold 50. If desired, the second conduit 40 can be thermally insulated with an insulation wrap 42 to prevent temperature increase of the nitrous oxide. The manifold 50 is fluidly connected to a fitting 46, which is secured to the downstream end of the second conduit 40.

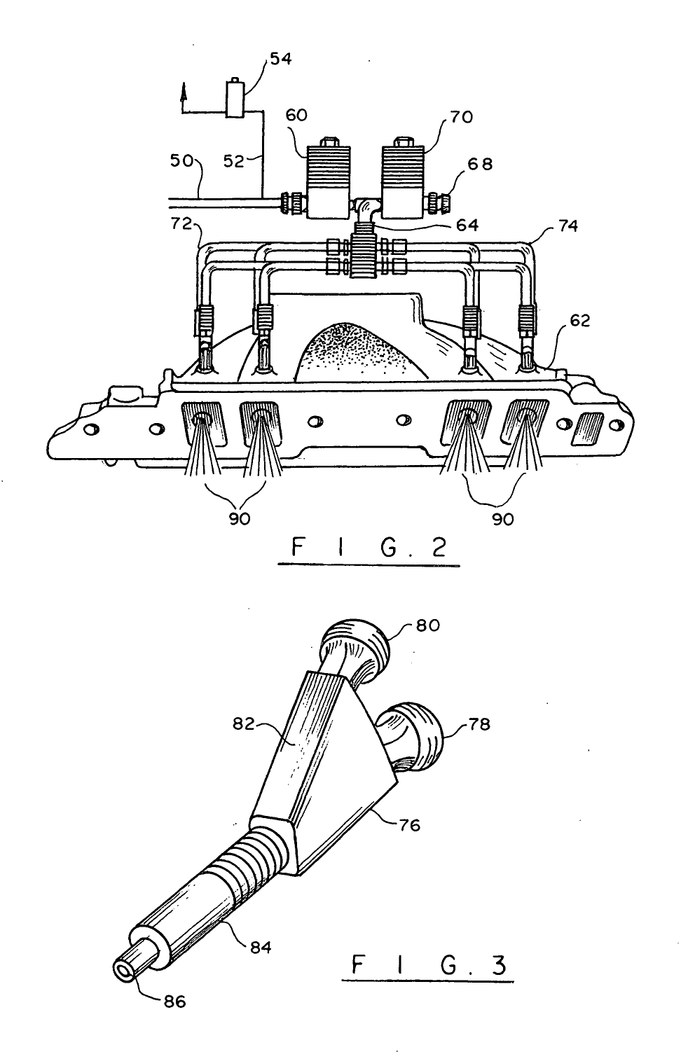

As can be seen in FIG. 2, the manifold 50 is fluidly connected to a purge line 52, which allows the car driver to purge the fuel system by venting nitrous vapors to the atmosphere at the start of the system use. A solenoid 54 operationally connected to the vehicle electrical system is incorporated into the purge line 52.

Downstream from the purge line 52, the manifold 50 is connected to a high capacity solenoid 60, which operates delivery of the nitrous oxide to the engine 62. FIG. 2 illustrates an 8-cylinder engine, although 6-cylinder and 4-cylinder engines can benefit from the use of the system of the present invention as well. A distribution block 64 is positioned in operational communication with the manifold 50. The distribution block 64 is designed to distribute balanced amounts of nitrous and fuel to the engine 62.

The distribution block 64 also receives a flow of engine fuel through an engine fuel intake line 68 mounted adjacent the manifold 50. A second high capacity solenoid 70 regulates delivery of the engine fuel from a fuel tank (not shown) of the vehicle.

A plurality of nitrous delivery lines 72 are connected to outlet ports of the distribution block 64. A plurality of fuel delivery lines 74 are connected to the fuel outlet ports of the distribution block 64. Each nitrous delivery line 72 and each fuel delivery line 74 connect with a nozzle assembly 76. In one aspect of the invention, the nozzle assembly 76 comprises a nitrous inlet member 80 and a fuel inlet member 80, each of which is provided with exterior threads for detachable connection to the corresponding delivery lines.

The nozzle assembly 76 comprises a hollow main body portion 82, which forms a mixing chamber where nitrous oxide and fuel are mixed in a desired balanced proportion. A jet nozzle fitting 84 is secured to the main body portion 82 opposite the nitrous inlet member 80 and the fuel inlet member 80. The jet nozzle fitting 84 has a through opening allowing injection of the mixture of nitrous oxide and fuel directly into the path of oxygen. The jet nozzle fitting 84 is provided with an outlet orifice 86, through which the mixture of nitrous oxide and fuel is forced into the cylinder of the engine in a flow schematically designated by numeral 90 in FIG. 2.

In one aspect of the invention, the diameter of the orifice 86 is made intentionally small, between 0.01 inches and 0.05 inches (0.254 mm and 1.27 mm) as compared to a standard size of 0.03-0.032″ (076-0.81 mm). The tests demonstrated that standard size orifice (0.03-0.032) causes introduction of too much oxygen, which can burn the engine.

The decreased size orifice 86 allows maintaining of pressure in the delivery system of nitrous oxide and fuel. During experimental tests it was determined that the use of 0.028″ orifice in a 1200HP engine provides an additional 700HP for a total of 1900HP with the cooling system of the present invention.

It is envisioned that the change in the nitrous volume may also require a change in the injection of fuel—there would be more fuel required if there was more oxygen supplied. Since there would be fuel a longer burn time may be required. As a consequence it is possible that the timing be set more ahead of dead center than normal such that the system gets a pre-burn, and that at top dead center for the piston that the car would get the most powerful burn for the down push of the cylinder.

During operation, the driver opens the nitrous oxide bottle 12, opens the ball valve 24, opens the ball valve 38 on the exit of the cooling unit and then purges the system by use of the solenoid purge valve 54 to ensure that the most concentrated nitrous oxide gas is supplied up to the solenoid.

The solenoid valves 60 and 70 will be opened upon acceleration thereby injecting dense cold nitrous oxide in the intake manifold 50, where it is immediately mixed with fuel in addition to the carburetor which is also injected via a solenoid at about 6 pounds of pressure. The volume of fuel may be adjusted because of the increase of nitrous oxide in the nozzle assemblies 90. The change in the volume of fuel can be accomplished by changing out the orifices 86 at the injection point.

The tests demonstrated that the direct injection the nitrous oxide into the manifold produces about 200 horsepower over a standard 1200 horsepower engine that is running off carburetors giving a total of 1400 horsepower. The instant system allows delivery of an additional 700 horsepower added to the already available 1200HP engine making a total of 1900 horsepower.

Cooling of the nitrous oxide is contrary to a conventional method of cryogen delivery, where the systems are built on the need for more pressure in a nitrogen bottle so as to get more nitrogen through the orifice. In one particular class of race cars, the rules require the injection orifice to be 0.032″, although some classes allow up to 0.05″. The instant invention, instead of increasing the orifice size to the maximum allowed, provides for a decreased size orifice, decreasing the required pressure in the nitrous oxide tank and providing a richer, more dense (increased number of molecules) into the intake to be mixed as an oxidizer with the fuel and directly injected into the manifold at the point of the intake to the piston chamber. By slightly increasing the timing of the firing of the spark plug, somewhat before top dead center, the instant system balances the delivery of efficient fuel mixture for an engine.

It is envisioned that the system of the present invention can be used for retrofitting gasoline-powered cars having internal combustion engines for the purpose of improving the engine performance. In such a case, the nitrous oxide container and the cooling unit can be positioned in the cabin to allow the driver to open and close delivery of the nitrous oxide to the engine. The system is connected to the electrical circuit of the vehicle, so that purging can be performed by the driver depressing the acceleration pedal.

Many changes and modifications can be made in the system of the present invention without departing from the spirit thereof. I, therefore, pray that my rights to the present invention be limited only by the scope of the appended claims.

I claim:

1. A nitrous-oxide system for an internal combustion engine having a fuel line, the system comprising:
a closed container with nitrous oxide under pressure;
a first conduit connected to the container and configured for delivery of nitrous oxide from the container;
a cooling unit mounted downstream from the first conduit, said cooling unit comprising a hollow cooling tubing fluidly connected to a free end of the first conduit, said cooling unit being configured to retain a cooling medium in a surrounding relationship to the cooling tubing;
a second conduit connected to an outlet end of the cooling tubing; and
a nozzle assembly, operationally connected to the second conduit and operatively coupled to an engine intake; said nozzle assembly comprising a jet nozzle fitting configured to inject a mixture of nitrous oxide and fuel into the engine intake.

2. The system of claim 1, wherein the nozzle assembly is provided for each cylinder of the internal combustion engine.

3. The system of claim 1, wherein the cooling tubing comprises a coiled tubing provided with an opening and configured for transporting nitrous oxide from the first conduit to the second conduit.

4. The system of claim 1, wherein the cooling medium is water ice retained at a temperature of about 0° C.

5. The system of claim 1, wherein the cooling medium is dry ice.

6. The system of claim 1, wherein the cooling unit comprises a housing sized and configured to house the cooling tubing and cooling medium therein.

7. The system of claim 1, wherein the nozzle jet fitting has an orifice with a diameter of between 0.01 and 0.05 inches.

8. The system of claim 1, wherein the nozzle jet fitting has an orifice with a diameter of 0.028 inches.

9. The system of claim 1, wherein the first conduit is provided with a first check valve mounted between the first conduit and the cooling tubing.

10. The system of claim 9, wherein said check valve is a ball valve.

11. The system of claim 9, wherein the second conduit is provided with a check valve mounted between the cooling tubing and the second conduit.

12. The system of claim 11, wherein the check valve mounted between the cooling tubing and the second conduit is a ball valve.

13. A nitrous-oxide system for an internal combustion engine having a fuel line, the system comprising:
a closed container with nitrous oxide under pressure;
a first high pressure conduit connected to the container and configured for delivery of nitrous oxide from the container;
a cooling unit mounted downstream from the first conduit, said cooling unit comprising a hollow coiled tubing fluidly connected to a free end of the first conduit, said coiled tubing being configured for transporting the nitrous oxide from said first conduit at a temperature of at or below 0° C., said cooling unit being configured to retain a cooling medium in a surrounding relationship to the coiled tubing;
a second conduit connected to an outlet end of the cooling tubing; and
a nozzle assembly, operationally connected to the second conduit and operatively coupled to an engine intake; said nozzle assembly comprising a jet nozzle fitting configured to inject a mixture of nitrous oxide and fuel into the engine intake.

14. The system of claim 13, wherein the nozzle assembly is provided for each cylinder of the internal combustion engine.

15. The system of claim 1, wherein a first check valve is mounted at an inlet of the cooling unit and a second check valve is mounted at an outlet of the cooling unit for regulating delivery of the nitrous oxide to the engine.

16. The system of claim 15, wherein each of the first check valve and the second check valve is a ball valve.

17. The system of claim 13, wherein the cooling medium is water ice retained at a temperature of about 0° C.

18. The system of claim 13, wherein the cooling medium is dry ice.

19. The system of claim 13, wherein the cooling unit comprises a housing sized and configured to house the coiled tubing and cooling medium therein.

20. The system of claim 13, wherein the nozzle jet fitting has an orifice with a diameter of between 0.01 and 0.05 inches.

21. The system of claim 13, wherein the nozzle jet fitting has an orifice with a diameter of 0.028 inches.

22. A method for retrofitting an engine of a gasoline powered vehicle having an internal combustion engine with a nitrous-oxide system, comprising the step of:
providing a source of pressurized nitrous oxide;
providing a nozzle assembly coupled to the source of nitrous oxide and positioning the nozzle assembly in fluid communication with a fuel line of each cylinder of the internal combustion engine;
providing a cooling unit between the source of nitrous oxide and the nozzle assembly, said cooling unit maintaining temperature of nitrous oxide at or below 0° C.

23. The method of claim 22, further comprising a step of providing a first conduit and connecting the first conduit between the source of the nitrous oxide and the cooling unit, said first conduit carrying a first check valve.

24. The method of claim 23, further comprising a step of providing a second conduit and connecting the second conduit between the cooling unit and the nozzle assembly, said second conduit carrying a second check valve.

25. The method of claim 24, wherein each of the first check valve and the second check valve is a ball valve.

26. The method of claim 22, wherein the nozzle assembly comprises a nozzle jet fitting configured for delivery of a mixture of nitrous oxide and engine fuel into an engine cylinder.

27. The method of claim 26, wherein the nozzle jet fitting has an orifice with a diameter of between 0.01 and 0.05 inches.

28. The method of claim 26, wherein the nozzle jet fitting has an orifice with a diameter of 0.028 inches.
